(19) United States
(12) Patent Application Publication
(10) Pub. No.: US 2011/0238469 A1
(43) Pub. Date: Sep. 29, 2011

(54) Method and Systems for Providing Digital Incentives Using Post-Transaction Data

(76) Inventors: Alex GERSHMAN, Falls Church, VA (US); Eric Reuthe, Franklin, TN (US); Thomas J. Graves, Nashville, TN (US)

(21) Appl. No.: 12/731,814

(22) Filed: Mar. 25, 2010

(51) Int. Cl. G06Q 30/00; G06Q 40/00

(52) U.S. Cl. 705/14.17

(57) ABSTRACT

Systems and methods for automatically providing digital incentives post-settlement or post-transaction for electronic payment card accounts at the financial institution level.

### BACKGROUND OF THE INVENTION

1. Field of the Invention

The present invention relates generally to financial systems and methods. Further, the present invention relates to digital incentives for electronic financial transactions and systems and methods relating thereto.

2. Description of the Prior Art

Merchants and service providers often utilize various forms of incentives to attract new customers and to gain repeat business with prior customers. These incentives generally range from traditional paper coupons to rewards programs that incentivize customer loyalty by awarding customers reward currency for qualifying transactions and allowing customers to redeem accumulated reward currency for discounts, merchandise, or other benefits.

Merchants and manufacturers have long used paper coupons to provide potential customers with incentives to patronize a specific store or to purchase particular products or services. Paper coupons are often delivered through the mail, newspapers, store flyers, and printers located at checkout counters. More recently, email and websites have also been used to deliver coupons for printing. In addition, online merchants regularly provide online coupons, known as coupon codes, for use at the checkout phase of an online purchase. Furthermore, some merchants now send coupons directly to consumers' mobile phones as text messages. Finally, some merchants utilize closed-loop loyalty card systems in which customers are provided loyalty cards associated with loyalty accounts and the merchants can automatically deliver coupons to the associated accounts.

Coupons, in all forms, allow merchants to provide incentives to potential customers. For customers, coupons provide a benefit at the time of purchase, not at some later time, as is typically the case with rewards programs based on reward currency accumulation. However, coupons have several disadvantages. Paper coupons require that the consumer manually collect the coupons, remember to bring the coupons to the appropriate store, and to manually present the coupons at the time of purchase. In addition, paper coupons require merchants to train employees to process the coupons. While coupons delivered automatically to mobile phones and closed-loop loyalty accounts reduce the effort required to collect coupons, consumers are still required to bring their mobile phones or closed-loop loyalty cards to the store in addition to a form of payment in order to receive the benefit of the coupon.

Relevant prior art related to coupons includes the following:

U.S. Pat. No. 4,723,212 entitled “Method and Apparatus for Dispensing Discount Coupons” and issued Feb. 2, 1988, to Mindrum et al. discloses an “apparatus, and a corresponding method, for creating a discount coupon in response to the purchase of a product other than the one to which the coupon applies.”

U.S. Pat. No. 5,649,114 entitled “Method and System for Selective Incentive Point-of-Sale Marketing in Response to Customer Shopping Histories” and issued Jul. 15, 1997, to Deaton et al. discloses entering a customer's identification code, along with customer transaction data, at the point-of-sale, a memory that stores a database of previously entered customer identification codes and transactions data, and a circuitry for generating a signal representative of a customer's shopping history, wherein incentive coupons may be issued to customers in dependence upon the signal.

U.S. Pat. No. 6,076,068 entitled “Coupon Delivery System” and issued Jun. 13, 2000, to DeLapa et al. discloses a “computer-implemented method and apparatus for generating coupons to provide discounts for purchases [which] includes providing a computer-based kiosk at a retail establishment such as a grocery store.”

Prepaid cards are a second form of incentive utilized by merchants. Prepaid cards are debit cards generally purchased by a consumer for later use and are often required to be used at a specific merchant or set of merchants. Consequently, prepaid cards allow merchants to receive money prior to providing any merchandise or service. Once a prepaid card has been purchased, it provides an incentive for the consumer to use it since the expenditure of money has already been made in advance. However, since the prepaid cards generally require consumers to spend money at a time before they receive any goods or services, there is little incentive to purchase a prepaid card outside of a special context, such as gift giving or fundraising. Therefore, prepaid cards often provide little actual incentive for a consumer to patronize a particular merchant or service provider.

In addition to offering prepaid cards for purchase, some merchants use prepaid cards as a method to distribute rewards from their respective customer loyalty and rewards programs. While the prospect of receiving a prepaid card upon achievement of a preset requirement of a loyalty and rewards program provides customer incentive, the benefit to the customer is delayed until a point in time after the time of purchase. This delay is in direct contrast to a coupon-type incentive, which benefits a customer immediately at the point of sale.

Relevant prior art related to prepaid cards include: http://www.parago.com/prepaidcards

Loyalty and rewards programs are popular incentive tools used by merchants and service providers. These programs generally reward customer loyalty by crediting a consumer's rewards account with a reward currency—points, miles, reward dollars, etc.—upon the completion of a qualifying transaction and allowing the consumer to redeem accumulated reward currency for merchandise, services, or discounts. Some loyalty and reward program implementations provide rebates or discounts to the consumer based on the achievement of preset milestones. In general, loyalty and reward programs reward a pattern of customer loyalty performed in the past with a future reward. While these programs provide an incentive for consumers, the consumers must wait until a point in time after one or more purchases have been made before realizing any program-related benefit. Consumers do not receive any immediate benefit at the point of sale as they would with coupon-type incentives.

Traditional implementations of loyalty and rewards programs often issue a separate rewards card to be scanned or swiped at the time of sale in order to credit the rewards account of the customer. Consequently, the consumer is required to carry an additional device to take advantage of the rewards program. In other implementations, merchants partner with banks or credit card companies to issue credit or debit cards with a second magnetic strip. At the time of purchase, a store clerk swipes the card once through a card reader to initiate payment and then performs a second swipe to credit the customer's rewards account. This latter implementation carries with it the disadvantage of requiring store clerks to be trained to perform additional tasks and, depending on the implementation, requiring the merchant to have additional equipment. Other implementations have resolved these issues in the loyalty and rewards context by allowing a single swipe of an individual credit/debit card to initiate payment, credit rewards accounts, and to redeem awards previously earned.

Relevant prior art related to loyalty and reward programs include the following:

U.S. Published Patent Application No. 20090030793 entitled “Multi-Vendor Multi-Loyalty Currency Program” and published Jan. 29, 2009, to Fordyce discloses that “in addition to obtaining payment for the merchant from the account via an acquirer and an issuer, respectively, a transaction handler tabulates and stores, different types of loyalty currencies in a loyalty reward account associated with the account holder if the account holder is enrolled in a loyalty program and criteria for applying the loyalty program are satisfied.”

U.S. Published Patent Application No. 20050240477 entitled “Cardholder Loyalty Program with Rebate” and published Oct. 27, 2005, to Friday et al. discloses a system and method for implementing a program such as a loyalty program. An account (e.g., card) system includes a plurality of participating account holders (e.g., cardholders), a plurality of non-participating account holders (e.g., cardholders), a plurality of non-preferred merchants and a plurality of preferred merchants. A processor executes the program including evaluating transactions to identify qualifying transactions involving both a participating account holders (e.g., cardholders) and a preferred merchant. Rebates are provided for identified, qualifying transactions.

U.S. Pat. No. 5,025,372 entitled “System and Method for Administration of Incentive Award Program Through Use of Credit” and issued Jun. 18, 1991, to Burton et al. discloses “computer data processing, programming and printing for an improved incentive award program which allocates monetary amounts available for expenditure through credit instruments issued to program participants when the participants perform to a designated level of achievement.”

U.S. Published Patent Application No. 20020026348 entitled “Marketing Systems and Methods” and published Feb. 28, 2002, to Fowler et al. discloses “systems and methods implementing a plurality of marketing programs, offered by a plurality of merchants or merchant groups, upon presentation of a qualifying identifier, such as a (single) transaction card. Yet another aspect of the present invention provides methods and systems enabling a “single-swipe” transaction, wherein data is selectively packeted and transmitted to one or more institutions following a single electronic reading of a transaction card.”

Note that marketing programs of the prior art are implemented using a host controller that communicates with a plurality of remote transaction systems to provide real-time, individualized, automated awards and sophisticated multi-variable analysis of transaction data.”

U.S. Published Patent Application No. 20080103968 entitled “Redemption of Credit Card Rewards at Point of Sale” and published May1, 2008, to Bies et al. discloses “systems and methods . . . for redeeming rewards at a merchant's point-of-sale. The reward redemption takes place in real time and can be accomplished without the active participation of the merchant. A single credit card with no additional information may be used with a single swipe from the consumer to access both credit and rewards accounts, such that a single authorization request is made to encompass both rewards and credit.”

U.S. Published Patent Application No. 20060053056 entitled “Card Member Discount System and Method” and published Mar. 9, 2006, to Alspach-Goss et al. discloses a “method and apparatus to facilitate giving a discount to a consumer subsequent to a point of sale purchase . . . if the purchase qualifies for a discount under one or more discount programs, the consumer's financial account is charged the full, agreed upon purchase price, and subsequently credited one or more discounts the transaction qualifies for without the consumer needing to perform a secondary task(s).”

U.S. Published Patent Application No. 20080235091 entitled “Cash in Advance Incentive and Rewards Program” and published Sep. 25, 2008, to Holliday discloses a system wherein “consumers are provided with a rewards card in advance of earning the rewards through online purchases.”

Note that under the prior art systems consumers must complete transactions before getting reward and then take additional steps proactively in order to receive a rebate; once a preset amount of money is spent a rebate check is issued.

U.S. Published Patent Application No. 20090012862 entitled “Instant Zero Inventory Fulfillment and Redemption System and Method” and published Jan. 8, 2009, to Pirillo et al. discloses an “instant fulfillment system [that] allows members of programs, such as an incentive, reward, affinity or loyalty program, to use an instant reward card to redeem currency or points stored in a database, for instant ‘rebates’ or ‘discounts’ at selected retailers.”

U.S. Published Patent Application No. 20030158818 entitled “Systems and Methods for Operating Loyalty Programs” and published Aug. 21, 2003, to George et al. discloses “A loyalty system that may be integrated with a financial infrastructure . . . . Such a financial infrastructure may accommodate transactions involving participants in the loyalty program as well as transactions that do not involve participants in the loyalty program.”

U.S. Pat. No. 7,506,804 entitled “System and Method for an Integrated Payment and Reward Card” and issued Mar. 24, 2009, to Zajkowski et al. discloses “an integrated rewards card [that] includes a credit card number associated with a credit account of a person, persons, entity or a business. The integrated rewards card also includes a debit card number. The debit card number is different then the credit card number. Purchases using the credit card number cause a reward balance on a reward account associated with the debit card number to be increased. Products or services can be purchased with the reward account using a point of sale device for the credit card number.”

U.S. Published Patent Application No. 20060027647 entitled “System and Method for Redeeming Awards and Incentives” published Feb. 9, 2006, to Deane et al. discloses a “transaction card, including a substrate having a front face and a back face, a first magnetic stripe for storing data associated with a credit account, the first magnetic stripe being located along an edge of the back face, a second magnetic stripe for storing data associated with a rewards account, the second magnetic stripe being located along another edge of the back face, and account information located on the front face, the account information being associated with the credit account and the rewards account.”

### SUMMARY OF THE INVENTION

A first aspect of the present invention is to provide a method for providing digital incentives or financial offsets including the steps of: providing a financial platform for applying digital incentives to consumer electronic payment accounts, the financial platform being operable on a digital incentives (DI) server computer having at least one database in electronic, digital communication over a network with at least one financial institution (FI) server computer, the financial platform operable for automatically creating digital incentives applicable directly to at least one user's electronic payment card account at the FI server computer; automatically applying a digital incentive program for stimulating financial transactions of the at least one user's electronic payment card, the digital incentive program including profile factors from the profile data of the at least one user; and automatically providing at least one digital incentive to corresponding electronic payment card account(s) of the at least one user, the at least one digital incentive applied as a credit to the electronic payment card account data at the FI server computer.

A second aspect of the present invention is to provide a system for providing digital incentives including: a financial system operable on a digital incentives (DI) server computer and at least one database in electronic, digital communication over a network with at least one financial institution (FI) server computer, the financial platform operable for automatically applying digital incentives to qualifying financial services transactions associated with predetermined electronic payment cards; a digital incentive program operable within the financial system and the DI and FI server computers for stimulating financial transactions by the users, by transforming accounts at a consumer level by automatically applying post-transaction credits to those accounts after a match between the digital incentives, electronic payment card transactions and their corresponding accounts at the FI server computer.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a schematic diagram view of the system and its methods for providing digital incentives of the present invention, using post-transaction data.

FIG. 2 (FIG. 1 from −002) illustrates a schematic diagram view of the system for providing digital incentives of the present invention.

### DETAILED DESCRIPTION

The present invention provides a method for providing digital incentives or financial offsets including the steps of: providing a financial platform operable on a server computer and at least one database in electronic, digital communication over a network, the financial platform operable for financial services transactions; providing a database of profile data for the at least one user; developing a digital incentive program for stimulating financial transactions by at least one user, the digital incentive program including profile factors from the profile data of the at least one user; automatically providing at least one digital incentive to corresponding of the at least one user, the at least one digital incentive available for a redemption by each of the users, wherein the digital incentive has an electronic financial transaction value available for the redemption on any electronic financial transaction media, and wherein the redemption of the electronic financial transaction value of the digital incentive does not occur at a merchant level of the financial transactions.

The present invention also provides a system for providing digital incentives including: a financial system operable on a server computer and at least one database in electronic, digital communication over a network, the financial platform operable for financial services transactions; the financial system interacting with a database of profile data for a multiplicity of users; a digital incentive program operable within the financial system and the server computer for stimulating financial transactions by the users, the digital incentive program including profile factors from the profile data of the users and automatically providing at least one digital incentive to corresponding users, the at least one digital incentive available for a use by each of the users, wherein the digital incentive has an electronic financial transaction value available for the use on any electronic financial transaction media, and wherein the use of the electronic financial transaction value of the digital incentive does not alter the financial transactions for the merchant accepting payment for the transaction.

Additionally, the present invention includes a computer readable code stored in a storage medium and executable by one or more processors, which when executed perform the method steps including: automatically providing at least one digital incentive to an electronic payment card account of a user, the system automatically applying an electronic financial transaction value associated with the digital incentive(s) that is automatically applied as a credit to the electronic payment card account at the financial institution level, the digital incentive application being triggered by the user making a qualifying transaction, i.e., using the electronic payment card for making a payment for goods or services associated with the at least one active digital incentive within a digital incentives program; providing a credit for the electronic financial transaction made using the electronic payment card, the credit being applied to the corresponding account at a financial institution level, wherein the account is selected from a demand deposit account, credit, debit, or prepaid account of the at least one user. Notably, the automatic application of the digital incentive as a credit to the electronic payment card account doe not directly affect a merchant level of the financial transaction, and so it is not a coupon or discount at the merchant level directly, but rather it is applied directly a credit to the electronic payment card user, and does not require any integration or interaction directly with the credit card processor or data processor that operates outside the financial institution server computer. Thus the digital incentives systems and methods of the present invention solves the issues of time and complexity associated with integration with data processors.

The present invention methods and system address the issues of managing the integration with electronic payment card transaction data processors, perhaps most significantly the time it takes to do so. While processor integration for data access to electronic payment card purchase transactions in essentially real time is attractive, the present invention methods and systems provide an alternative that eliminates the processor integration yet provides access to the data from a post-settlement or post-transaction timeframe and extends digital incentives as a reward in this manner. Significantly, and advantageously, the present invention provides digital incentives as credit to the consumer's account on a post-settlement or post-transaction manner that are independent of any card program manager or electronic payment card transaction data processor.

For example, if a credit card user has the option of selectively activating his/her electronic payment card for a predetermined program with a given merchant that is nationwide in the US, the methods and systems of the present invention provide for digital incentive offering automatically to that user based upon his/her location and demographics. Furthermore, the present invention systems and methods preferably automatically match the post-transaction or post-settlement data associated with a purchase made by that user with his/her electronic payment card, matching that data with the electronic payment card statement data to provide a credit allocation to the balance of that electronic payment card account; this post-settlement or post-transaction digital incentive is selected or activated based upon consumer inputs in advance of a purchase, a qualifying transaction or purchase is made by the consumer with that electronic payment card, the system automatically matches the qualifying transaction with existing digital incentive programs to confirm the amount and type of digital incentive applicable to the transaction and that user's electronic payment card account, and then the system automatically creates a corresponding digital incentive and automatically allocates it as a credit to that consumer's particular electronic payment card account at the financial institution level.

These methods are operable and executable by the present invention system automatically, without third party approval, based upon the inputs from consumer selection for activation of the digital incentive program(s) and qualifying electronic payment transactions that are confirmed and matched in a post-transaction or post-settlement timing. The matching is performed at predetermined timing, and data from transactions made by electronic payment methods are considered in comparison with the digital incentives programs periodically, for example, based upon data provided by the financial institution associated with the electronic payment card or account of the consumer, based upon the approval provided by the consumer at the time of registration for the digital incentives program.

Referring now to the drawings in general, the illustrations are for the purpose of describing preferred embodiments of the invention and are not intended to limit the invention thereto.

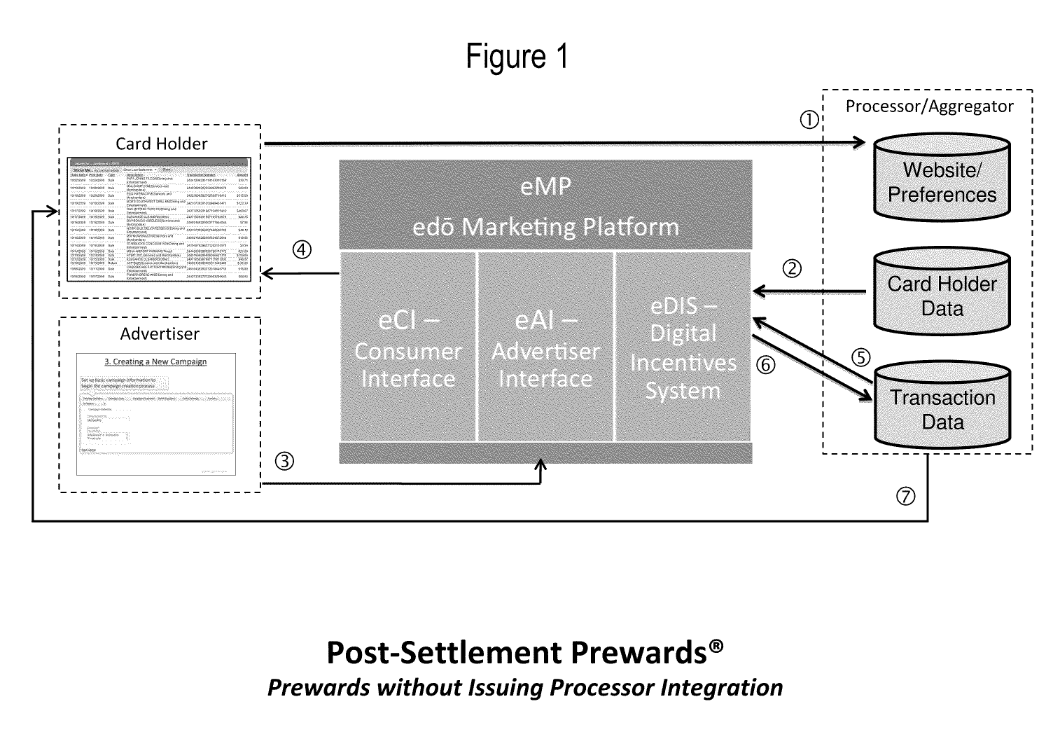

FIG. 1 illustrates a schematic diagram view of the system and its methods for providing digital incentives of the present invention, using post-transaction data, without requiring integration with electronic payment transaction data processors.

Method steps associated with the system of the present invention include the following: providing a system having at least one digital incentives (DI) server computer with a processor, a memory, and input/output devices that is constructed and configured for electronic communication via a network with at least one financial institution (FI) server computer having consumer(s) electronic payment transaction data stored thereon, the at least one DI server computer further including software operable thereon for automatically converting and transforming the input data from the at least one FI server computer relating to consumer(s) electronic payment transaction data, matching eligible transactions with selective digital incentives programs identified by inputs from the consumer as “preferred” or “selected” for application to at least one electronic payment card and corresponding account with the FI, and automatically providing digital incentive offsets or credits to that account based upon the match, all done without integration and/or direct communication with the non-FI data processor associated with the electronic payment card (such as a credit card processor).

The system and methods provide for receiving inputs from a consumer, when the consumer opts in for predetermined available digital incentives programs and associates them with at least one electronic payment card and corresponding account associated with a financial institution.

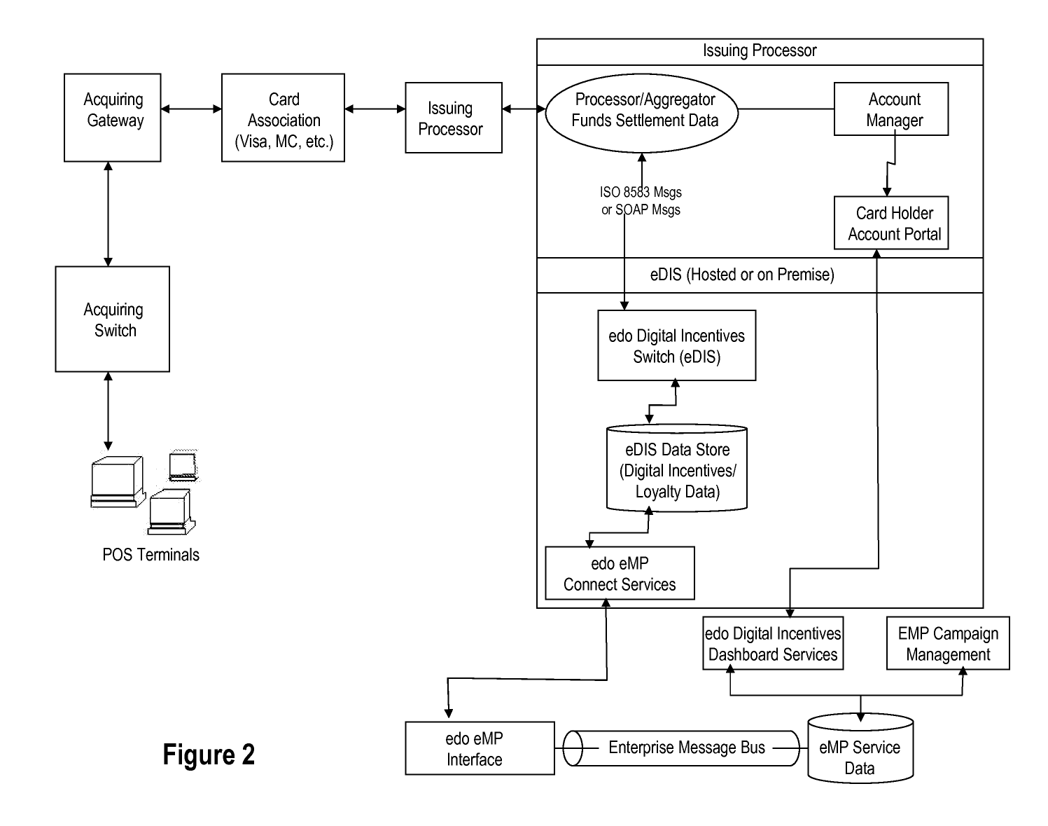

By contrast to the present invention, FIG. 2 illustrates a schematic diagram view of the system for providing digital incentives, wherein the digital incentives switch (DIS) is associated with, configured and connected for electronic communication with an issuing processor system. Merchant transactions are initiated at point of sale (POS) terminals, either on location of a merchant or service provider, such as a payment register computer, or online, via a website providing for commercial transactions for goods and/or services order and payment, wherein the website is accessed remotely via a user at a remote computer in electronic communication with a network, such as the Internet, to access the interactive website for input/output of information relating to the transaction through a graphic user interface on the remote computer. The POS terminals automatically communicate electronically via a network with an acquiring switch and an acquiring gateway, and then a card association function and issuing processor system, as illustrated.

Again, FIG. 1 illustrates a schematic diagram of the system and methods for providing digital incentives of the present invention, showing at least one digital incentives server computer in networked communication, and having a digital incentives program associated therewith, the server computer including a processing engine, wherein the processing engine within the DI server computer includes a processor, memory, power, input/output, all components operable and in electronic connection and communication via a network for access to a database stored on at least one financial institution (FI) server computer having data relating to electronic payment transactions for accounts associated with that FI, and digital incentives, including available incentives and redeemed incentives for each account and/or corresponding user associated with the electronic payment card(s) and selected or activated DI programs in advance of eligible transactions being made using the electronic payment card(s). The FI is an issuing bank for those electronic payment card(s), having issuing bank account information and data for each card holder(s) or user(s), corresponding cards, corresponding bank accounts. The issuing bank or FI server computer is connected via networked electronic communication with a digital incentives account that provides for credits or offset(s) post-transaction or post-settlement to the relevant accounts for which the digital incentives are properly redeemed and matched by the digital incentives switch. The digital incentives switch sends and receives messages from the issuing FI systems, based upon information and/or communication electronically received via a network relating to post-settlement transactions (or post-transactions), typically relating to the purchase of goods and/or services (at a merchant level, also referred to as merchant transactions). The digital incentives switch is operable with the digital incentive (DI) processing engine to identify an available digital incentive that is applicable to transform the account balance for a predetermined electronic payment card in association with a matching transaction, based on the information provided by the FI server computer for post-settlement transactions made by the consumer using the predetermined electronic payment card(s).

As illustrated with FIG. 1, method steps of the present invention include a system operable for providing digital incentives to be automatically applied to an electronic payment card account for a user at a financial institution level based on the following inputs and automatic system actions:

1. Consumer opts in for digital incentives program and shares communication/offer preferences on Processor/Card Program/Aggregator website

2. the financial institution as Processor/Aggregator sends participating Card Members data to the digital incentives program (including communication/offer preferences);

3. Advertiser sets up preward campaign and the digital incentives (DI) server computer automatically activates and assigns a digital incentives offer from the DI program to qualifying Card Members (based on Card Holder data/preferences and Advertiser targeting criteria);

4. Offer is presented to qualifying card holders via statements, account dashboard and/or e-mail/text communications;

5. Processor/Aggregator sends daily transaction file to the digital incentives (DI) server computer having the digital incentives program and corresponding database thereon;

6. the DI server computer automatically matches transactions and sends to the financial institution (FI) server computer for the Processor/Aggregator a “top-up file” for qualifying purchases (note: if “Top-Up” cannot be made, the DI server can create a prepaid account to be funded with preward funds and withdrawn by the Card Member or user);

7. FI server computer automatically applies Preward/posts “Top-Ups” to automatically transform the account balance of the Card Holder account (see above if “Top-Up” cannot be provided) by automatically applying a credit corresponding with the digital incentive from the DI server computer.

Significantly, the present invention systems and methods provide digital incentives within a financial system relating to electronic payment transactions for goods and/or services made automatically following a match between the qualifying or eligible transactions and digital incentives that are applied as a credit to that account at the financial institution level of the account, all without any communication directly with or integration with a credit card data processor, wherein the digital incentives impact the user account as an offset or credit and do not directly affect any aspect of the merchant level transaction, such as in the prior art discount or coupons, or as in the prepaid cards or advance rewards, wherein the merchant payment upon activation and use of the prepaid cards or advance rewards cards is a discounted payment, wherein the actual payment to the merchant is less than the retail transaction value for the payment for the goods and/or services at the time of purchase.

Certain modifications and improvements will occur to those skilled in the art upon a reading of the foregoing description. By way of example and not limitation, the preward digital incentive may be provided, authorized, and allocated based upon documentation included within a credit card user's statement; in this case, there digital incentives are indicated on the cardmember statement in the following statement period or automatically updated in the electronic status of the account provided by the financial institution issuing the account. Preferably, an interactive graphical user interface on a display related to a website accessible via a computer network provides the user with access to information about the digital incentives authorized, available, and/or selectable for use without affecting a purchase transaction at the merchant level (consistent with the foregoing methods); however, the matching is provided directly through the financial transactions recordation and documentation associated with the user financial statement, such as a credit card statement, and does not include any digital incentives switch interface. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A method for providing digital incentives or financial offsets comprising the steps of:
providing a financial platform for applying digital incentives to consumer electronic payment accounts, the financial platform being operable on a digital incentives (DI) server computer having at least one database in electronic, digital communication over a network with at least one financial institution (FI) server computer, the financial platform operable for automatically creating digital incentives applicable directly to at least one user's electronic payment card account at the FI server computer;
applying a digital incentive program for stimulating financial transactions of the at least one user's electronic payment card, the digital incentive program including profile factors from the profile data of the at least one user;
automatically providing at least one digital incentive to corresponding electronic payment card account(s) of the at least one user, the at least one digital incentive applied as a credit to the electronic payment card account data at the FI server computer.

2. The method of claim 1, further including the step of the DI server computer automatically providing an electronic digital credit to the FI server computer after a match between the digital incentives program and a transaction identified from the data provided by the FI server computer, thereby transforming the account balance associated with the user's electronic payment card account associated with the financial institution.

3. The method of claim 1, further including the step of tracking the application of the digital incentive.

4. The method of claim 1, further including the step of reporting the application of the digital incentive.

5. The method of claim 1, wherein the electronic payment card includes debit, credit, and prepaid electronic payment cards, wireless digital electronic device transactions, and bank account transactions.

6. The method of claim 1, further including the step of providing an interactive user interface on a website operable for access by the at least one user to manage his/her digital incentives associated with the electronic payment card(s) and active digital incentives programs.

7. The method of claim 6, wherein website provides information about the number and type of digital incentives available for each of the at least one user.

8. The method of claim 6, wherein website provides information about the number and type of digital incentives previously applied for each of the at least one user.

9. A computer readable code stored in a storage medium and executable by one or more processors, which when executed perform the method steps comprising:
automatically providing an electronic communication for at least one digital incentive to at least one electronic payment card account of at least one user, the electronic payment card account having data associated therewith at a financial institution (FI) database,
applying an electronic financial transaction credit post-settlement at the FI database after a match is detected between active digital incentives and a qualifying transaction made with a predetermined electronic payment card having an account stored on the FI database;
providing a credit for the electronic financial transaction credit at the FI database for the account, demand deposit account, credit, debit, or prepaid account of the at least one user, without directly affecting a merchant level of the financial transaction.

10. The code of claim 9, the code further including executable steps for tracking the use of the at least one digital incentive by the users.

11. The code of claim 9, the code further including executable steps for reporting results from tracking the application of the at least one digital incentive.

12. The code of claim 9, wherein the code is operable without requiring direct interaction or integration with a credit card data processor.

13. A system for providing digital incentives comprising:
a financial system operable on a digital incentives (DI) server computer and at least one database in electronic, digital communication over a network with at least one financial institution (FI) server computer, the financial platform operable for automatically applying digital incentives to qualifying financial services transactions associated with predetermined electronic payment cards;
a digital incentive program operable within the financial system and the DI and FI server computers for stimulating financial transactions by the users, by transforming accounts at a consumer level by automatically applying post-transaction credits to those accounts after a match between the digital incentives, electronic payment card transactions and their corresponding accounts at the FI server computer.

14. The system of claim 13, wherein the server computer transforms the financial transaction at a bank account level of each user, applying the digital incentive as a credit.

15. The system of claim 13, wherein the system is accessible to a set of selected users via an interactive user interface on a website.

16. The system of claim 13, wherein the use of the electronic financial transaction value of the digital incentive does not alter the financial transactions for the merchant accepting payment for the transaction.
